(19) United States
(12) Patent Application Publication
(10) Pub. No.: US 2016/0269132 A1
(43) Pub. Date: Sep. 15, 2016

(54) SIGNAL BOOSTER FOR A CONTROLLABLE ANTENNA SYSTEM

(71) Applicant: WILSON ELECTRONICS, LLC, St. George, UT (US)

(72) Inventors: James Colin Clark, Washington, UT (US); Patrick Lee Cook, St. George, UT (US); Christopher Ken Ashworth, St. George, UT (US); Michael James Mouser, Parker, TX (US); Stephen Todd Fariss, Frisco, TX (US)

(21) Appl. No.: 15/065,750

(22) Filed: Mar. 9, 2016

Related U.S. Application Data
(60) Provisional application No. 62/130,588, filed on Mar. 9, 2015.

(51) Int. Cl. H04B 17/318; H04W 16/18

(52) U.S. Cl. CPC H04B 17/318; H04W 16/18

(57) ABSTRACT

A controllable antenna system is disclosed. The system comprises a directional antenna configured to be directed in a selected direction. A radio frequency detector is configured to measure a power level of a signal. A control unit is configured to send a control signal to direct a directional antenna in a selected direction based on the measured power level to transmit or receive. A signal booster may be configured to reduce attenuation and/or increase signal quality of the signal.

### RELATED APPLICATIONS

This application claims the benefit under 35 U.S.C. §119(e) of U.S. Provisional application No. 62/130,588 filed on Mar. 9, 2015 the entirety of which is hereby incorporated by reference.

### FIELD

The embodiments discussed herein are related to signal booster.

### BACKGROUND

In a wireless communication system, communication may occur as uplink communications and downlink communications. Uplink communications may refer to communications that originate at a wireless communication device (referred to hereinafter as “wireless device”) and that are transmitted to an access point (e.g., base station, remote radio head, wireless router, etc.) associated with the wireless communication system. Downlink communications may refer to communications from the access point to the wireless device.

Sometimes a wireless device in a wireless communication system may be positioned such that it may not receive uplink and/or downlink communications from an access point at a desired power level. In these situations, a user of the wireless device may employ a signal booster to boost the uplink and/or downlink communications.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates an example wireless communication system in accordance with an example embodiment;

FIG. 2 illustrates an example booster system in accordance with an example embodiment;

FIG. 3A illustrates an example portion of a booster system in accordance with an example embodiment;

FIG. 3B illustrates another example portion of a booster system in accordance with an example embodiment;

FIG. 4A illustrates a controllable antenna in accordance with an example embodiment;

FIG. 4B illustrates an electrically scannable and/or electrically steerable antenna in accordance with an example embodiment;

FIG. 5 illustrates a display of a signal booster in accordance with an example embodiment; and

FIG. 6 illustrates an example of a control unit in accordance with an example embodiment.

### DESCRIPTION OF EMBODIMENTS

An initial overview of technology embodiments are provided below and then specific technology embodiments are described in further detail later. This initial summary is intended to aid readers in understanding the technology more quickly but is not intended to identify key features or essential features of the technology nor is it intended to limit the scope of the claimed subject matter.

Cellular systems are typically comprised of handsets, referred to herein as a “wireless device”, that are configured to communicate with a cellular base station or other type of wireless access point such as an evolved node B (eNB). The handsets, also referred to as mobile stations (MS) or user equipment (UE), can include omnidirectional antennas, thereby enabling the handset to receive a signal from, and transmit a signal to a base station independent of the alignment between the handset and the base station.

In certain situations, the signal communicated from the base station to the hand set can be attenuated below a desired threshold level. The attenuation may be caused by a distance between the base station and the handset, line of sight issues between the base station and the handset caused by geography, buildings, infrastructure, and so forth,

One option to reduce attenuation and/or increase signal quality of a cellular signal is to use a signal booster. The signal booster may be configured to amplify, repeat, filter, and/or otherwise process received wireless signals, such as cellular signals from the base station (downlink) or handset (uplink), and may be configured to re-transmit the processed cellular signals to the handset (downlink) or base station (uplink).

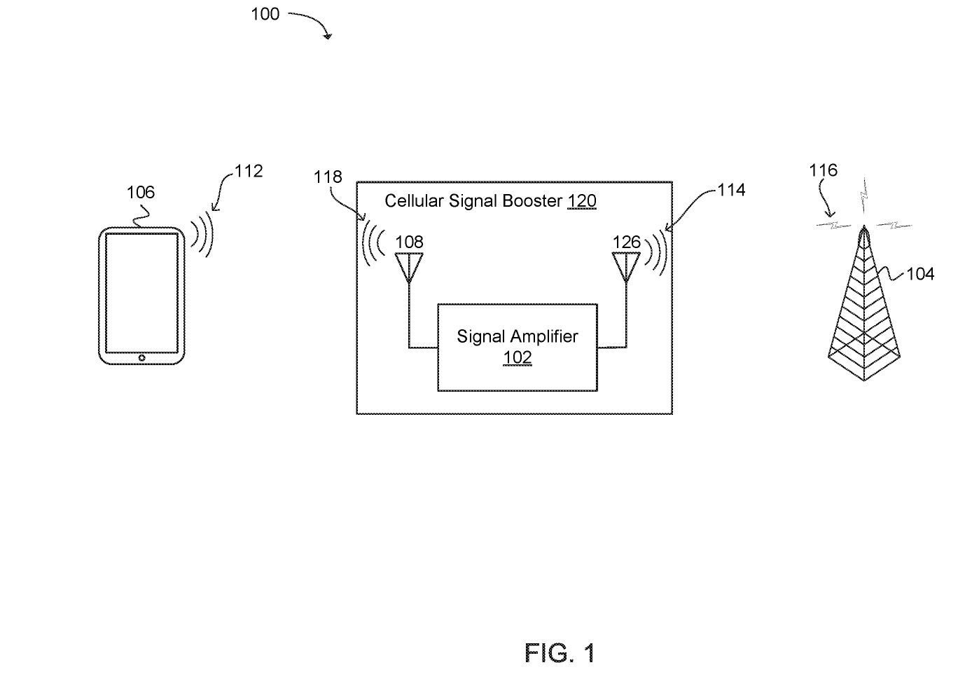

FIG. 1 illustrates an example wireless communication system 100 (referred to hereinafter as “system 100”), arranged in accordance with at least some embodiments described in this disclosure. The system 100 may be configured to provide wireless communication services to a wireless device 106, such as a handset, via an access point 104, such as a cellular base station. The system 100 may further include a cellular signal booster 102 (referred to hereinafter as “the signal booster 102”). The signal booster 102 may be any suitable system, device, or apparatus configured to receive wireless signals (e.g., radio frequency (RF) signals) communicated between the access point 104 and the wireless device 106. In certain embodiments, the cellular signal booster 102 can be a bidirectional signal booster, enabled to process both uplink and downlink signals. In alternative embodiments, the cellular signal booster 102 may be configured to only process uplink signals or downlink signals. In certain embodiments, the signal booster 102, and corresponding antennas 108 and 110, can be installed at a fixed location, such as at a building or house. A directional antenna can be used to increase the gain of a received wireless downlink signal 116 or received wireless uplink signal 112. To optimize the gain, the directional antenna can be pointed or directed towards the access point 104 or wireless device 106.

In other embodiments, the signal booster 102 and corresponding antennas 108 and 110 can be installed in a mobile environment, such as on a vehicle, or setup at a temporary location. In the mobile or temporary embodiments, it can be difficult to direct the antennas 108 and/or 110 to a selected position to receive a desired uplink or downlink signal from the wireless device 106 or access point 104. In order to direct the antenna(s) 108 and/or 110 to a selected position in a mobile or temporary environment, the antenna(s) 108 and/or 110 can be mechanically or electrically steered to the selected position. By measuring desired components and/or qualities of a received wireless signal, and using a feedback mechanism, the antenna(s) 108 and/or 110 can be electrically and/or mechanically scanned, steered, or directed to provide a desired signal power and/or signal quality of the received wireless signal. This can significantly enhance the operation of the signal booster 102 in mobile or temporary embodiments. The electrical and/or mechanical scanning, steering, or directing of the antenna(s) 108 and/or 110 will be more fully described in the proceeding paragraphs.

The wireless communication services provided by the system 100 may include voice services, data services, messaging services, and/or any suitable combination thereof. The system 100 may include a Frequency Division Duplexing (FDD) network, a Frequency Division Multiple Access (FDMA) network, an Orthogonal FDMA (OFDMA) network, a Code Division Multiple Access (CDMA) network, a Time Division Multiple Access (TDMA) network, a Direct Sequence Spread Spectrum (DSSS) network, a Frequency Hopping Spread Spectrum (FHSS) network, and/or some other wireless communication network. In some embodiments, the system 100 may be configured to operate as a second generation (2G) wireless communication network, a third generation (3G) wireless communication network, a fourth generation (4G) wireless communication network, and/or an Institute of Electronics and Electrical Engineers (IEEE) 802.11 (Wi-Fi) network. The Wi-Fi network can include IEEE standard releases 802.11-2012, 802.11ac-2013, 802.11ad, and 802.11ax. In these or other embodiments, the system 100 may also be configured to operate as a Third Generation Partnership Project (3GPP) Long Term Evolution (LTE) or LTE Advanced wireless communication network, including but not limited to, 3GPP LTE Rel. 8, 9, 10, 11, 12 or 13.

The access point 104 may be any suitable wireless network communication point and may include, by way of example but not limitation, a base station, a remote radio head (RRH), a satellite, a wireless router, or any other suitable communication point. The wireless device 106 may be any device that may use the system 100 for obtaining wireless communication services and may include, by way of example and not limitation, a cellular phone, a smartphone, a personal data assistant (PDA), a laptop computer, a personal computer, a tablet computer, a wireless communication card, or any other similar device configured to communicate within the system 100.

As wireless signals propagate between the access point 104 and the wireless device 106, the wireless signals may be affected during the propagation such that, in some instances, the wireless signals may be substantially degraded. The signal degradation may result in the access point 104 or the wireless device 106 not receiving, detecting, or decoding information from the wireless signals. Therefore, the signal booster 102 may be configured to increase the power of and/or improve the signal quality of the wireless signals such that the communication of the wireless signals between the access point 104 and the wireless device 106 may be improved.

In some embodiments, the signal booster 102 may receive a wireless signal communicated between the access point 104 and the wireless device 106 and may convert the wireless signal into an electrical signal (e.g., via an antenna). The signal booster 102 may be configured to amplify the electrical signal and the amplified electrical signal may be converted into an amplified wireless signal (e.g., via an antenna) that may be transmitted. The signal booster 102 may amplify the electrical signal by applying a gain to the electrical signal. The gain may be a set gain or a variable gain, and may be less than, equal to, or greater than one. Therefore, in the present disclosure, the term “amplify” may refer to applying any gain to a wireless signal including gains that are less than one.

In some embodiments, the signal booster 102 may adjust the gain based on conditions associated with communicating the wireless signals (e.g., providing noise floor, internal oscillation, external oscillation (e.g., antenna to antenna oscillations), and/or overload protection). In these and other embodiments, the signal booster 102 may adjust the gain in real time. The signal booster 102 may also filter out noise associated with the received wireless signal such that the retransmitted wireless signal may be a cleaner signal than the received wireless signal. Therefore, the signal booster 102 may improve the communication of wireless signals between the access point 104 and the wireless device 106.

For example, the wireless device 106 may communicate a wireless uplink signal 112 intended for reception by the access point 104 and a first antenna 108 may be configured to receive the wireless uplink signal 112. The first antenna 108 may be configured to convert the received wireless uplink signal 112 into an electrical uplink signal. Additionally, the first antenna 108 may be communicatively coupled to a first interface port (not expressly depicted in FIG. 1) of the signal booster 102 such that the signal booster 102 may receive the electrical uplink signal from the first antenna 108 at the first interface port. An interface port may be any suitable port configured to interface the signal booster 102 with another device (e.g., an antenna, a modem, another signal booster, etc.) from which the signal booster 102 may receive a signal and/or to which the signal booster 102 may communicate a signal.

In some embodiments, the signal booster 102 may be configured to apply a gain to the electrical uplink signal to amplify the electrical uplink signal. In the illustrated embodiment, the signal booster 102 may direct the amplified electrical uplink signal toward a second interface port (not expressly depicted in FIG. 1) of the signal booster 102 that may be communicatively coupled to a second antenna 110. The second antenna 110 may be configured to receive the amplified electrical uplink signal from the second interface port and may convert the amplified electrical uplink signal into an amplified wireless uplink signal 114 that may also be transmitted by the second antenna 110. The amplified wireless uplink signal 114 may then be received by the access point 104.

In some embodiments, the signal booster 102 may also be configured to filter the electrical uplink signal to remove at least some noise associated with the received wireless uplink signal 112. Consequently, the amplified wireless uplink signal 114 may have a better signal-to-noise ratio (SNR) than the wireless uplink signal 112 that may be received by the first antenna 108. Accordingly, the signal booster 102 may be configured to improve the communication of uplink signals, which may be first direction signals, between the access point 104 and the wireless device 106. The use of the term “uplink signal,” without specifying wireless or electrical uplink signals, may refer to wireless uplink signals or electrical uplink signals.

As another example, the access point 104 may communicate a wireless downlink signal 116 intended for the wireless device 106 and the second antenna 110 may be configured to receive the wireless downlink signal 116. The second antenna 110 may convert the received wireless downlink signal 116 into an electrical downlink signal such that the electrical downlink signal may be received at the second interface port of the signal booster 102. In some embodiments, the signal booster 102 may be configured to apply a gain to the electrical downlink signal to amplify the electrical downlink signal. The signal booster 102 may also be configured to direct the amplified electrical downlink signal toward the first interface port of the signal booster 102 such that the first antenna 108 may receive the amplified electrical downlink signal. The first antenna 108 may be configured to convert the amplified electrical downlink signal into an amplified wireless downlink signal 118 that may also be transmitted by the first antenna 108. The amplified wireless downlink signal 118 may then be received by the wireless device 106.

In some embodiments, the signal booster 102 may also be configured to filter the electrical downlink signal to remove at least some noise associated with the received wireless downlink signal 116. Therefore, the amplified wireless downlink signal 118 may have a better SNR than the wireless downlink signal 116 received by the second antenna 110. Accordingly, the signal booster 102 may also be configured to improve the communication of downlink signals, which may be second direction signals, between the access point 104 and the wireless device 106. The use of the term “downlink signal,” without specifying wireless or electrical downlink signals, may refer to wireless downlink signals or electrical downlink signals.

Modifications may be made to the system 100 without departing from the scope of the present disclosure. For example, in some embodiments, the distance between the signal booster 102 and the wireless device 106 may be relatively close as compared to the distance between the signal booster 102 and the access point 104. Further, the system 100 may include any number of signal boosters 102, access points 104, and/or wireless devices 106. Additionally, in some embodiments, the signal booster 102 may be coupled to multiple antennas, like the first antenna 108, which are configured to communicate with wireless devices. Also, in some embodiments, the signal booster 102 may be included in a cradle configured to hold the wireless device 106. Additionally, in some embodiments, the signal booster 102 may be configured to communicate with the wireless device 106 via wired communications (e.g., using electrical signals communicated over a wire) instead of wireless communications (e.g., via wireless signals).

Additionally, although the signal booster 102 is illustrated and described with respect to performing operations with respect to wireless communications such as receiving and transmitting wireless signals via the first antenna 108 and the second antenna 110, the scope of the present disclosure is not limited to such applications. For example, in some embodiments, the signal booster 102 (or other signal boosters described herein) may be configured to perform similar operations with respect to communications that are not necessarily wireless, such as processing signals that may be received and/or transmitted via one or more modems or other signal boosters communicatively coupled to the interface ports of the signal booster 102 via a wired connection.

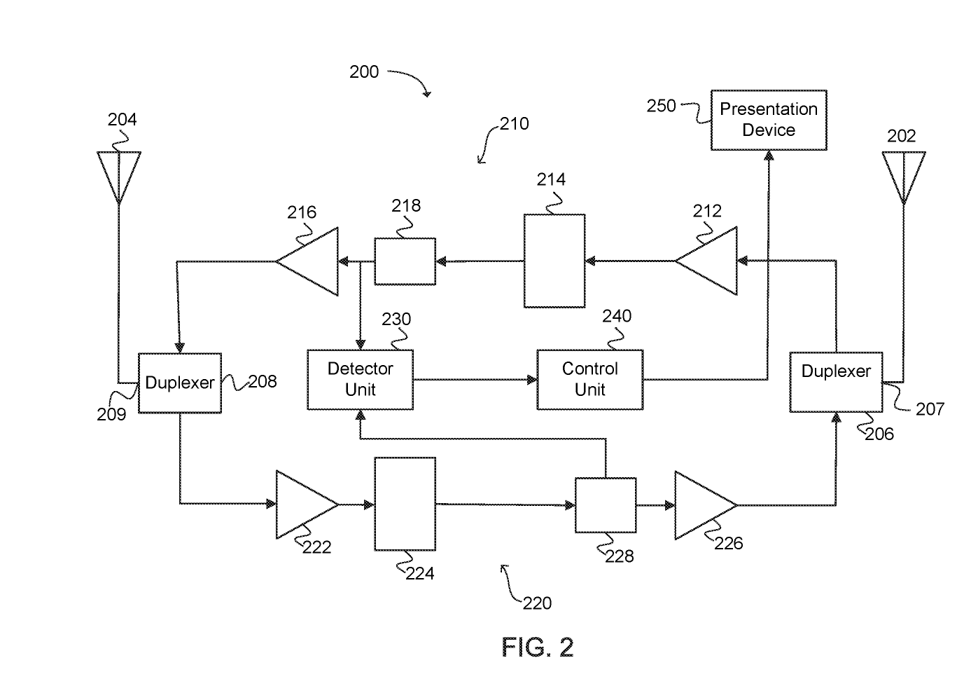

FIG. 2 illustrates an example signal booster 200, arranged in accordance with one or more embodiments as described in the detailed description. The signal booster 200 may include a first antenna 202, first duplexer 206, a second antenna 204, and a second duplexer 208. A downlink signal path 210 and an uplink signal path 220 may be coupled between a first port 207 and a second port 209. In this example the first and second ports comprise first and second duplexers 206 and 208. While a duplexer is provided as an example, other types of signal splitters and/or combiners can also be used. The downlink signal path 210 may include a first amplifier chain 212, a first filter circuit 214, a second amplifier chain 216, and a first tap circuit 218. The uplink signal path 220 may include a third amplifier chain 222, a second filter circuit 224, a second tap circuit 228, and a fourth amplifier chain 226.

Each of the amplifier chains 212, 216, 222, and 226 may include one or more power amplifiers, low noise amplifiers, attenuators, or other elements arranged in any order. Each of the filter circuits 214 and 224 may be one or more filters. The filters may be band pass filters, low pass filters, high pass filters, or some combination thereof.

The downlink signal path 210 may be configured to apply an amplification factor to a downlink signal passing through the signal booster 200. The first tap circuit 218 may be configured to provide a portion of the downlink signal passing through the downlink signal path 210 to the detector unit 230.

The uplink signal path 220 may be configured to apply an amplification factor to an uplink signal passing through the signal booster 200. The second tap circuit 228 may be configured to provide a portion of the uplink signal passing through the uplink signal path 220 to the detector unit 230.

The detector unit 230 may be configured to detect a power level of the received uplink signal and/or the received downlink signal. In one embodiment, the detector unit 230 can be a received signal strength indicator (RSSI). The detector unit 230 can be configured to scan for a particular carrier or carrier channel. An auto scanning algorithm can be used for signal detection and to enable the detector unit 230 to lock on to the desired signal. The detector unit 230 can be configured to automatically scan or manually scan. The detector may be configured to scan for a signal with a maximum power level. Alternatively, the detector may be configured to scan for the particular carrier or carrier channel that may not have a maximum power. The detector unit 230 may scan continuously, or at a selected interval. The detector unit 230 may only output the detected power level when a change in power level occurs. The detector unit 230 may provide the detected power levels to the control unit 240. The control unit 240 may be configured to receive the detected power levels from the detector unit 230. The control unit 240 may be configured to determine presentation power levels based on the detected power levels. In some embodiments, the presentation power levels may be the same as the detected power levels. In some embodiments, the presentation power levels may be an average of the detected power levels. Alternately or additionally, the presentation power levels may be a median, mean, peak, low, or some other combination of multiple detected power levels, where the multiple detected power levels are detected over time. For example, the presentation power levels may be a mean of 1,000 detected downlink power levels over time.

The control unit 240 may provide the presentation power levels to a presentation device 250. The presentation device 250 may be configured to present the presentation power levels to a user of the signal booster 200. For example, the presentation device 250 may be a display. In these and other embodiments, the presentation device 250 may display the presentation power levels. In some embodiments, the control unit 240 may provide the downlink presentation power levels to the presentation device 250 and not the uplink presentation power levels. In these and other embodiments, the control unit 240 may not determine the uplink presentation power levels.

Modifications, additions, or omissions may be made to the signal booster 200 without departing from the scope of the present disclosure. For example, the location of the tap circuits 218 and 228 may be different. The signal booster 200 may include more filters or amplifier chains in each of the downlink and uplink signal paths 210 and 220.

In some embodiments, the signal booster 200 may include multiple uplink and downlink paths coupled between the first and second antennas 202 and 204. Each of the uplink and downlink paths may provide a portion of the respectively downlink and uplink signals to the control unit 240 for presentation of the presentation device 250. Each of the uplink and downlink paths may be configured in a similar manner as the uplink and downlink paths 210 and 220. In these and other embodiments, the signal booster 200 may include multiple antennas for sending and receiving signals with a device, such as the device 106.

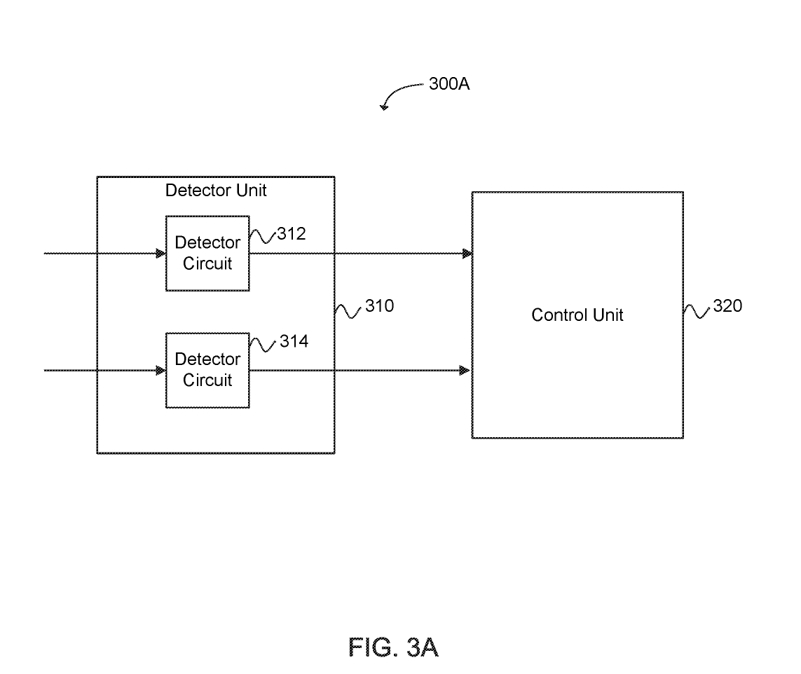

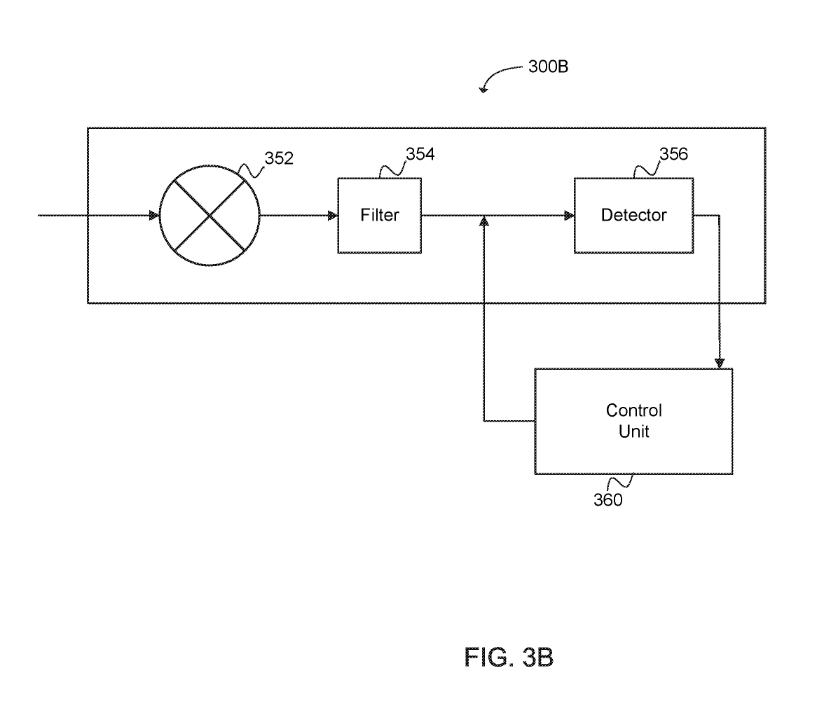

FIG. 3A illustrates an example portion 300A of a booster system, arranged in accordance with one or more embodiments as described in the present description. The portion 300A may include a detector unit 310, which includes a first detector circuit 312 and a second log detector circuit 314, and a control unit 320. The first detector circuit 312 may receive a portion of downlink signal. The first detector circuit 312 may output a first signal that is proportional to the RF power of the portion of the downlink signal to the control unit 320. The second detector circuit 314 may receive a portion of the uplink signal. The second detector circuit 314 may output a second signal that is proportional to the RF power of the portion of the uplink signal to the control unit 320. In some embodiments, the first and second signals may be analog or digital signals. In these and other embodiments, the detectors circuits 312 and 314 may be log detectors, ADC, diodes, or other RF detectors.

The control unit 320 may receive multiple first and second signals from the detector unit 310. In some embodiments, the first and second signals may be part of the same wireless communication frequency band. The frequency band may be any international E-UTRA operating band. In some embodiments, the control unit 320 may determine an aggregate signal power for the frequency band by combining and averaging the first and second signals. Alternately or additionally, the control unit 320 may sample the first signal and the second signal multiple times. In some embodiments, the control unit 320 may determine a mean, medium, or some combination of the multiple first signals and/or the multiple second signals. The control unit 320 may combine the mean, medium, or some combination of the multiple first signals and the multiple second signals to determine an aggregate signal power for the frequency band. Modifications, additions, or omissions may be made to the portion 300A of without departing from the scope of the present disclosure.

FIG. 3B illustrates another example portion 300B of a booster system, arranged in accordance with one or more embodiments as described in the detailed description. The portion 300B may include a detector unit 350, which includes a mixer 352, a filter 354, and a detector 356, and a control unit 360.

The portion 300B may be configured to determine signal power over multiple different frequency channels in the same wireless communication frequency band. In these and other embodiments, a portion of an uplink or downlink signal may be provided to the detector circuit 350. In particular, the portion of the signal may be provided to the mixer 352. The mixer 352 may down convert the signal to an intermediate frequency that is lower than the frequency of the signal. For example, the mixer 352 may down convert the signal to between 100 and 200 MHz. The mixer may provide the down converted signal to the filter 354. The filter 354 may be a band pass filter that passes a particular channel of the wireless communication frequency band. The filtered signal is then provided to the detector 356 that outputs a digital signal that is proportional to the power level of the filtered signal. In these and other embodiments, the digital signal may be a representation of the power level of the particular channel. The digital signal may be provided to the control unit 360.

In some embodiments, the control unit 360 may control the filter 354 to sweep the pass band of the filter across multiple channels in the same or different wireless communication frequency band. In these and other embodiments, the control unit 360 may receive the representation of the power level of the multiple different channels in the wireless communication frequency band. In these and other embodiments, the control unit 360 may receive multiple samples of in a particular channel before changing the pass band of the filter 354 to adjust the channel. In these and other embodiments, the channel may be more or less than 1 MHz.

In some embodiments, the portion 300B may determine a modulation scheme for the uplink and/or downlink signals. For example, the portion 300B may determine if the uplink and/or downlink signals modulated by TDD, FDD, LTE, GSM, or some other modulation scheme. In these and other embodiments, the portion 300A may determine the modulation scheme using multiple methods. In these and other embodiments, the detector 356 may include a front-end log detector configured to take multiple samples of different positions in the waveform if the signal and the strength of the signal at the different positions. Alternately or additionally, the detector 356 may include a diode detector that takes multiple samples of different positions in the waveform if the signal and the strength of the signal at the different positions. Alternately or additionally, the detector 356 may include an Analog to Digital Converter (ADC) that takes multiple samples of the signal at different points along a waveform of the signal. The detector 356 may provide the samples to the control unit 320. Using the samples, the control unit 320 may determine the modulation scheme. Modifications, additions, or omissions may be made to the portion 300B without departing from the scope of the present disclosure.

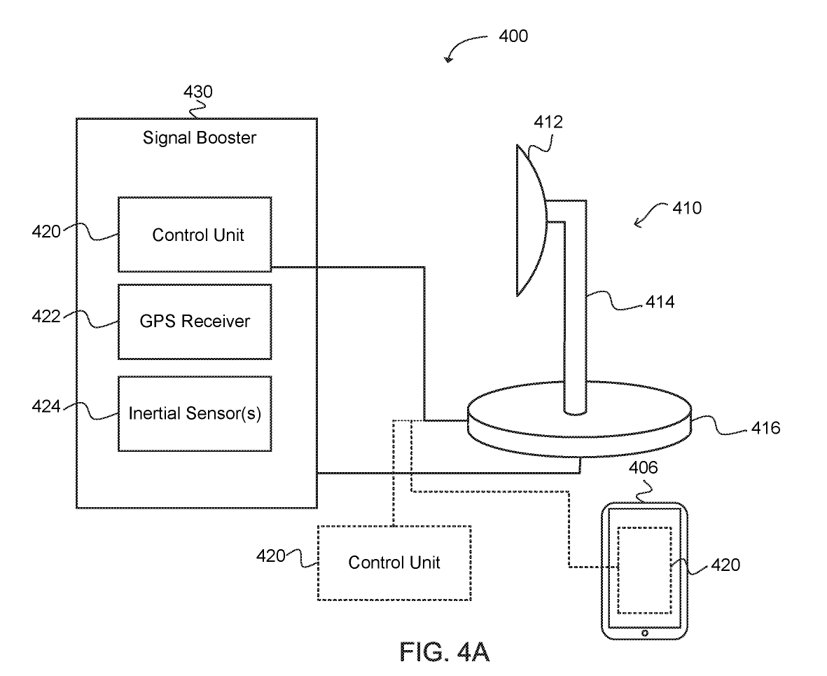

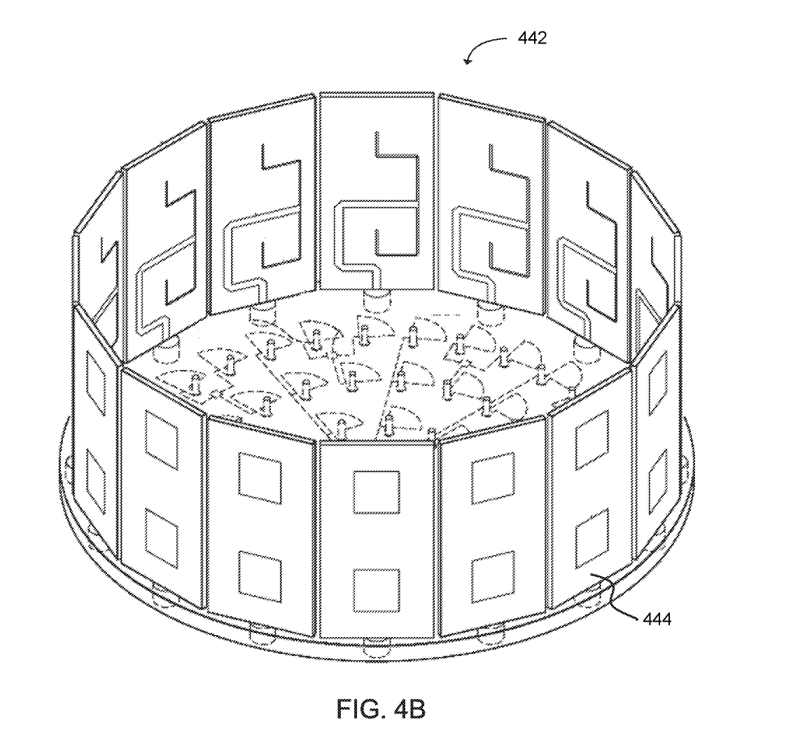

FIGS. 4A and 4B illustrate a controllable antenna system 400, arranged in accordance with one or more embodiments as described in the present disclosure. The system 400 may include a controllable antenna 410, which includes one or more of an antenna 412 or 442, an arm 414, an optional rotation unit 416, and a control unit 420. In one embodiment, the control unit 420 may be located in a signal booster 430. In another alternative, the control unit 420 can be a separate unit, or can be located in a wireless device 406 and the controllable antenna system 400 can be connected directly to the wireless device 406. The control unit can include a radio frequency (RF) pass-through detection and control box that can control motors/servos in the rotation unit 416 and/or antenna selection.

In one embodiment, the controllable antenna system 400 may be mounted on a moving vehicle, such as a recreational vehicle, an emergency vehicle, or another desired type of vehicle. In another embodiment, the controllable antenna system 400 can be configured to be setup at a temporary location, such as an emergency location, a camping site, a command post, or another type of temporary location. The control unit 420 can communicate to the rotation unit 416 and/or an electronically steerable or scanning antenna to enable the antenna 412 to be directed in a direction to transmit and/or receive a signal. While examples are provided for mobile and temporary embodiments, this is not intended to be limiting. The controllable antenna system 400 may also be used in an initial setup or reconfiguration of antennas for a signal booster 430 at a fixed location, such as a building or home.

In another embodiment, the controllable antenna system 400 may be activated to direct the controllable antenna 410 when motion is detected. For example, when the controllable antenna system 400 is mounted on a vehicle, a connection to the vehicle electronics can be used to provide motion and location information. In addition, connection to one or more inertial sensors can be used to provide information regarding velocity, time, position, altitude, or other desired information. A global positioning sensor (GPS) can be used to determine a location of the controllable antenna system 400. The GPS can be used to determine velocity, time, position, and altitude of the wireless device. This information can then be used to determine the amount of change in direction of the antenna in order to maintain the direction of the antenna 412, 442 at the access point 104 (FIG. 1).

The controllable antenna 410 may be coupled to a duplexer of the signal booster 430, such as the duplexer 206 of FIG. 2, by way of a coaxial cable or some other wired or wireless medium. In particular, the controllable antenna 410 may be coupled to a side of the signal booster that is configured to communicate with an access point, such as the access point 104 of FIG. 1. In these and other embodiments, the control unit 420 may be part of the signal booster that is coupled to the controllable antenna. The control unit 420 may be communicatively coupled to the rotation unit 416 by way of the wired or wireless medium. In some embodiments, the control unit 420 may be communicatively coupled to the controllable antenna 410 by way of the medium that couples the controllable antenna 410 to the duplexer of the signal booster.

The rotation unit 416 may be configured to rotate the antenna 412 based on a rotation signal from the control unit 420. In these and other embodiments, the rotation unit 416 may rotate the antenna 412 a full 360 degrees or some portion of 360 degrees. In some embodiments, the rotation unit 416 may rotate the antenna 412 in one or both directions.

The control unit 420 may direct the rotation of the antenna 412 using a feedback type control loop. The feedback type information may include a signal power level passing through the antenna as detected by the signal booster 430 coupled to the antenna 412. The signal power level may be for a downlink signal or an uplink signal. For example, as the control unit 420 adjusts the position of the antenna 412, the signal power level, as detected by the signal booster 430, may vary. The control unit 420 may receive an indication of the varying signal power level and may generate a rotation signal to have the rotation unit 416 adjust the position of the antenna 412 based on the amount of variance of the signal power level. In some embodiments, the control unit 420 may continuously or periodically direct the rotation unit 416 to adjust the position of the antenna 412 to a position based on an increase or decrease in the signal power level. Alternately or additionally, the control unit 420 may adjust the position of the antenna 412 during a set-up phase of the signal booster 430 and may not further direct the adjustment of the position of the antenna 412.

In addition to adjusting a direction of the position of the antenna 412 based on a measured signal strength, the direction of the position of the antenna can also be adjusted based on a predetermined geographic location of the access point 104 (FIG. 1) relative to a known geographic location of the wireless device 106 (FIG. 1). For example, a database may be used to identify a location of one or more access points based on a known location of the wireless device, or based on input data such as the selection of a state, city, zip code, and/or a current time. In one example embodiment, a rough adjustment of the direction of the antenna can be performed based on the geographic locations of the access point 104 and the wireless device 106. The direction of the antenna can then be fine-tuned based on the received signal strength, or other types of power or signal quality measurements of the received signal, as previously discussed.

In some embodiments, the control unit 420 may direct the rotation of the antenna 412 to optimize the position of the antenna 412 to optimize the power level of the signal received by the antenna 412 for a particular purpose. For example, in some embodiments, the position of the antenna 412 may be directed to reduce the power level of the signal received by the antenna 412 when the signal power level is above a threshold level. In these and other embodiments, directing the antenna 412 to reduce the power level of the signal can be used to assist the signal booster 430 in reducing the gain of the signal power level through a signal amplification path in the signal booster 430.

Alternately or additionally, the control unit 420 may direct the rotation of the antenna 412 to point to a strongest channel, band, or other portion of a band. For example, a signal booster 430 could detect the channels associated with a signal being amplified in the downlink channel to determine a carrier associated with a user that is using the signal booster 430. Alternately or additionally, a user of the signal booster 430 may input the carrier and/or channels being used. The signal booster 430 can determine the associated downlink channels for a carrier and then adjust the position of the antenna 412 to increase or decrease the signal power level of the particular channels for the carrier. Alternately or additionally, the control unit 420 may perform a similar procedure with an entire communication band instead of a channel.

Alternately or additionally, the control unit 420 may adjust the position of the antenna 412 based on one or more of a detected modulation scheme, detected bands of operations in a multi-band device, detected channels, a detected carrier, among other information.

In another embodiment, illustrated in the example of FIG. 4B, the antenna 442 can be an electrically steerable antenna or a scanning antenna. In this example, the antenna comprises a plurality of separate antennas 444 that can be mounted on a stationary mount or a rotatable mount, such as 414. Signals from different directions can be detected and received via the plurality of separate antennas 444. The control unit can be configured to switch and/or scan between the plurality of separate antennas 444. A direction of the signal can be determined based on the signal strength received on each antenna. One or more of the separate antennas 444 can be used to receive the strongest channel, band, or other portion of a band. Antennas that receive the desired strongest channel, band, or other portion of a band below a threshold level can be switched off to reduce noise.

Additional directivity can be obtained by configuring the separate antennas 444 as a phased array. The phase of each antenna can be adjusted to electronically steer a received and/or transmitted signal in a desired direction. The control unit 420 of FIG. 4a can be configured to steer the received and/or transmitted beam as desired.

While the example of FIG. 4b illustrates an antenna with separate antennas directed in 360 degrees, other configurations are also possible. For example, multiple antennas may be configured to transmit and/or receive a wireless signal over a selected portion of 360 degrees, such as 45, 60, 90, 180, or 270 degrees, or another desired arc. An antenna that receives over less than 360 degrees may be physically or electronically steered to receive signals over the full 360 degrees, or a desired portion of 360 degrees.

In one embodiment, multiple antennas 442 or 412 (FIG. 4A) may be directed in different directions to enable handover to occur in a cellular system from one base station to another base station. For example, a first antenna (or plurality of antennas) may be directed at a first base station. A second antenna (or plurality of antennas) may be directed at a second base station. The first base station, second base station, or a cellular network may instruct a wireless device to handover from the first base station to the second base station. The ability to direct separate antenna(s) at the first and second base station can allow nearly instantaneous switching between the first and second base stations, without the need to mechanically or electronically steer a controllable antenna from the first base station to the second base station for handover to occur. Since handover often occurs in cellular systems, and base stations may be in significantly different directions, the ability to direct an antenna at multiple base stations can be a significant advantage over systems configured for different types of communication, such as satellite communication, in which handover rarely occurs.

Returning to FIG. 4A, in another embodiment, the antenna 412 in the controllable antenna system 400 can include both an omnidirectional antenna and a directional antenna. The omnidirectional antenna may be switched in to assist the controllable antenna system 400 in receiving the desired wireless signal. For example, the omnidirectional antenna may be used in mobile embodiments, such as when a car is turning and the directional antenna has not yet rotated sufficiently towards the access point 114 (FIG. 1) to receive the signal at above a threshold level. The use of the omnidirectional antenna can allow the wireless signal to be received when the power level of the wireless signal received by the directional antenna is below the threshold level, thereby avoiding dropping the received wireless signal. An accelerometer, GPS, or other type of inertial measurement device can be used to determine when the vehicle is moving and/or turning to enable the controllable antenna system 400 to switch between a directional antenna, scannable antenna, or steerable antenna, and an omnidirectional antenna.

In addition, the omnidirectional antenna can be used to provide a baseline received signal strength indication to identify the environment in which the wireless device is located.

In another embodiment, two or more directional antennas, scannable antennas, or steerable antennas 412, 442 can be used. Each antenna can be independently controlled and directed. The use of two or more antennas that can be directed in different directions can be helpful for handover from one access point 114 (FIG. 1) to another access point. In another embodiment, the two or more directional antennas can include a low band directional antenna and a high band directional antenna. The low band and high band directional antennas may be combined with a diplexer to provide better performance than a splitter.

One or more of the antenna 412, 444, controllable antenna 410, rotation unit 416, control unit 420, and/or signal booster 430 can be contained within an enclosure. The enclosure can be a radome that is constructed to reduce weathering while minimally attenuating the electromagnetic signal transmitted or received by the antenna 412, 444.

The rotation unit 416 may be powered through the connection with the signal booster 430, such as through a direct current radio frequency connection, through batteries, through solar power, or through an alternate power source. Modifications, additions, or omissions may be made to the system 400 without departing from the scope of the present disclosure.

In one embodiment, a search can be performed for a desired signal. The search may comprise scanning a 360 degree zone, identifying selected signals, and the selecting one of the signals and physically rotating or electronically beamforming the antennas to transmit to or receive from an access port, such as a cellular base station. As previously disclosed, the selected signal may be a signal with maximum power. Alternatively, the selected signal can be a signal of a selected band or channel, or a signal from a selected base station or other type of access point.

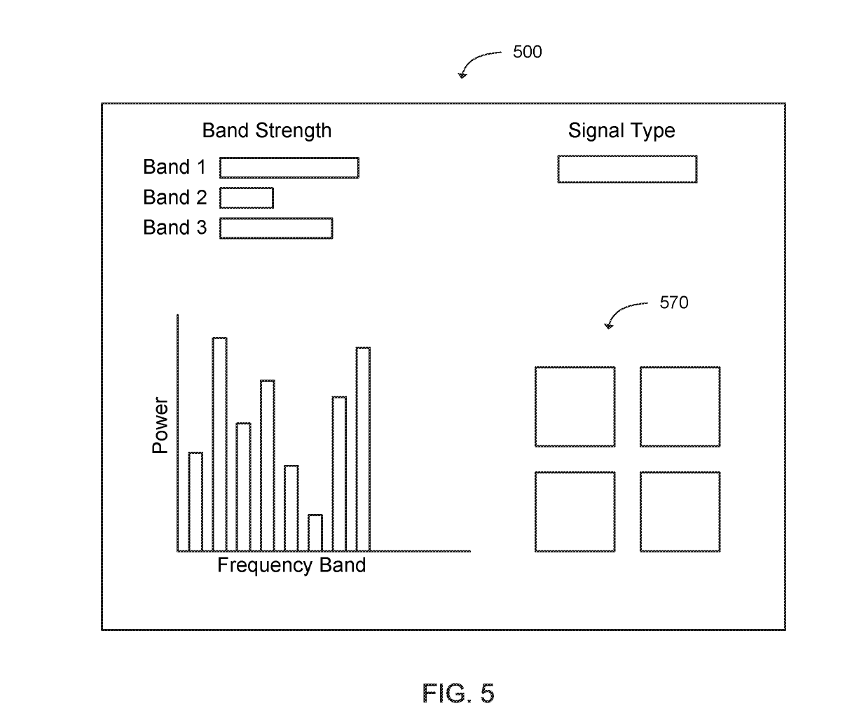

FIG. 5 illustrates a display 500 of a signal booster, arranged in accordance with one or more embodiments as described in the present disclosure. The display 500 may include buttons 510. The display 500 may be configured to display information about signal power levels of signal being passed by the signal booster. As illustrated, the display 500 may include a channel strength graph that illustrates the power level of multiple channels in a signal band. The display 500 may also include an area for displaying a signal type of a signal. Alternately or additionally, the display 500 may display a band strength of multiple bands that are configured to be amplified by the signal booster. In some embodiments, the display 500 may only display one of the above charts or information. In these and other embodiments, the buttons 510 may be used to toggle between the displays. For example, the band strength display may display a single band and the buttons may toggle between the multiple bands for which the signal booster is configured to operate.

In some embodiments, the display 500 may be a LED, LCD, or other type of display. The display 500 may be a signal color, multi-color, backlit, dark or other type of display 500. In some embodiments, the signal booster may be configured to emit an audible sound when a displayed band strength is above a particular level. In these and other embodiments, the signal booster may not include the display 500, but may be configured to emit the sound based on the detected power level of the signals. The display 500 may assist a booster installer with optimizing the antenna orientation, by showing a graphical maximum power indication when the antenna is receiving the most power. Alternately or additionally, a signal booster may automatically adjust its gain control when there is a strong downlink signal. In these and other embodiments, we could indicate on the screen the gain control occurs to help a user with installation.

Modifications, additions, or omissions may be made to the display 500 without departing from the scope of the present disclosure.

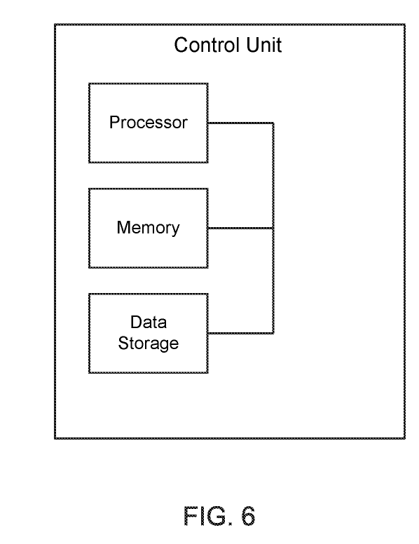

FIG. 6 illustrates a control unit 600 in signal booster, arranged in accordance with at least one embodiment of the present disclosure. As illustrated in FIG. 6, the control unit 600 may include a processor 610, a memory 612, and data storage 614. In these and other embodiments, the processor 610, the memory 612, and the data storage 614 may be configured to perform some or all of the operations performed by the control unit 600. In other embodiments, the system 600 may not include one or more of the processor 610, the memory 612, and the data storage 614. In these and other embodiments, the control unit 600 may perform one or more of the methods, process, determinations, or other calculations discussed with respect to a control unit in FIGS. 2-5.

Generally, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 6, it is understood that the processor 610 may include any number of processors distributed across any number of network or physical locations that are configured to perform individually or collectively any number of operations described herein. In some embodiments, the processor 610 may interpret and/or execute program instructions and/or process data stored in the memory 612, the data storage 614, or the memory 612 and the data storage 614. In some embodiments, the processor 610 may fetch program instructions from the data storage 614 and load the program instructions in the memory 612. After the program instructions are loaded into the memory 612, the processor 610 may execute the program instructions.

The memory 612 and data storage 614 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 610. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 610 to perform a certain operation or group of operations. Modifications, additions, or omissions may be made to the control unit 600 without departing from the scope of the present disclosure.

In another embodiment, a controllable antenna 410 (FIG. 4) having a signal booster 430 is disclosed. The controllable antenna having the signal booster comprises a first port 207 (FIG. 2) and a second port 209. A signal path, such as an uplink signal path 210 or a downlink signal path 220, can include a tap circuit 218, 228. The signal path is coupled between the first port and the second port 207 and the second port 209 and configured to pass a signal in a wireless communication network. The signal may be communicated from an antenna 202, 204 to the first port 207 or second port 209. In one embodiment, the signal path can be an amplification path configured to provide a desired amplification level or attenuation level to the signal.

The controllable antenna having the signal booster can further comprise a radio frequency detector circuit 230 communicatively coupled to the tap circuit 218, 228 and configured to measure a received power level of the signal. A control unit 240 can receive the measured power level of the signal from the radio frequency detector circuit 230 and output a control signal. In one embodiment, the control signal can be output to a presentation device 250. The control signal can also be output to the controllable antenna 410 and/or the rotation unit 416. A controllable antenna 410 can be configured to be coupled to one of the first port 207 or the second port 209. A controllable antenna beam-pattern can be directed by the control signal to a selected direction based, at least in part, on the received measured power level of the signal at the control unit 240. In one embodiment, the signal booster can be a cellular signal booster that is configured to operate in a cellular system and communicate with one or more base stations, eNBs, user equipment, mobile stations, or the like.

In one embodiment, the signal path can be an uplink signal path 210 that includes an uplink tap circuit 218. The uplink signal path can be coupled between the first port 207 and the second port 209 and configured to pass a wireless uplink signal in the wireless communication network. Alternatively, the signal path can be a downlink amplification path 220 that includes a downlink tap circuit 228. The downlink amplification path can be coupled between the second port 209 and the first port 207 and configured to pass a wireless downlink signal in a wireless communication network.

In one embodiment, the controllable antenna 410 is configured to be mechanically rotated to direct the beam pattern. A rotation unit 416 can be configured to rotate an antenna 412 according to the control signal. Alternatively, the controllable antenna can be configured to be electrically scanned or electrically steered to direct the beam pattern using one or more antennas. For instance, the controllable antenna can be configured to beam steer a signal in the selected direction.

In one embodiment, a plurality of controllable antennas 410 can be coupled to the first port 207 or the second port 209. One or more of the plurality of antennas 410 can be selected to scan for a selected signal or transmit a selected signal in the selected direction.

In another embodiment, each of the plurality of controllable antennas 410 can be directed independently of other antennas by the control unit 240 to enable each of the plurality of antennas to be directed in a selected direction. For example, two or more of the plurality of controllable antennas 410 can be directed to separate base stations (i.e. 104 of FIG. 1) to enable handover of a wireless device 106 in a cellular system from a first base station to a second base station to occur via the separately directed antennas 410.

The control unit 240 can be configured to output the control signal to direct the controllable antenna away from a maximum signal power of the signal to attenuate a received power level of the signal to a selected threshold.

In another embodiment, a controllable cellular antenna system is disclosed. The controllable cellular antenna system comprises: a first directional antenna configured to be directed in a first direction; a second directional antenna configured to be directed in a second direction, different from the first direction; and a control unit configured to send a first control signal to direct the first directional antenna and a second control signal to direct the second directional antenna. The directional antennas can each be a directional antenna 410 with a mechanically steerable antenna 412 or an electrically steerable antenna 442, as shown in FIGS. 4A and 4B.

The controllable cellular antenna system can further comprise a rotation unit 416 to rotate the first and second directional antennas based on the first control signal and the second control signal, respectively. The control unit 240 can be configured to provide the first control signal to electronically beam steer a first plurality of antennas 444 to transmit to or receive from a first base station in the first direction and the second control signal to electronically beam steer a second plurality of antennas 444 to transmit to or receive from a second base station in the second direction. The base stations can be represented by the base station 104.

In another embodiment, the control unit 240 can be configured to select one or more of a first plurality of antennas 412 to transmit to or receive from a first base station in the first direction and the control unit is configured to select one or more of a second plurality of antennas 412 to transmit to or receive from a second base station in the second direction. The base stations can be represented by the base station 104.

The control unit 420 can be located at one of a signal booster 430 in communication with the controllable cellular antenna system 410, a wireless device 406 in communication with the controllable cellular antenna system 410, and a housing 420 external from the signal booster 430.

In another embodiment, a signal booster for a controllable antenna system is disclosed. The signal booster for the controllable antenna system can comprise a signal booster 430 and a control unit 420. In one example, the signal booster 430 can comprise: a signal path for a signal 410, 420; a radio frequency detector unit 230 configured to measure a power level of the signal; and a control unit 240 configured to receive the power measurement and output a control signal to direct one or more directional antennas 410 in a selected direction.

The signal booster for the controllable antenna system can further comprise a power level presentation device 250 configured to display the measured power level of the signal to enable the one or more directional antennas 410 to be manually directed based on the displayed power level. In one example, the radio frequency detector unit 230 is configured to measure a received signal strength indication (RSSI) of the signal.

The control unit 420 can further be configured to output the control signal based on a predetermined geographic location of a base station (i.e. 104), relative to a location of the one or more directional antennas 410 to enable the one or more directional antennas to be directed towards the predetermined geographic location. The location of the one or more directional antennas can be determined using one or more of a known address of a location of the one or more directional antennas 410, a global positioning system receiver 422, or one or more inertial sensors 424.

In another embodiment, the control unit 420 can receive a power measurement for a plurality of signals over a selected scan radius. For example, one or more controllable antennas can be directed over a scan radius of 45 degrees, 90 degrees, 135 degrees, 180 degrees, 270 degrees, 360 degrees, or another desired radius, and the signals that have a received power that is greater than a selected threshold level can be detected and sent to the control unit 420. In one embodiment, a beacon signal can be measured signals transmitted from base stations. An angle of the one or more directional antennas can be identified for each of the received power measurements. One of the signals of the plurality of signals can be selected based on the received power measurements and the direction of the antennas at which the signal was received. A control signal can then be output to enable the one or more directional antennas to be directed towards the selected signal to allow an electronic device 406 to communicate with a base station or access point.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

What is claimed is:

1. A controllable antenna having a signal booster, comprising:
a first port;
a second port;
a signal path that includes a tap circuit, the signal path coupled between the first port and the second port and configured to pass a signal in a wireless communication network;
a radio frequency detector circuit communicatively coupled to the tap circuit and configured to measure a received power level of the signal;
a control unit to receive the measured power level of the signal from the radio frequency detector circuit and output a control signal; and
a controllable antenna coupled to one of the first port and the second port, wherein a controllable antenna beam-pattern is directed by the control signal to a selected direction based, at least in part, on the received measured power level of the signal at the control unit.

2. The controllable antenna having the signal booster of claim 1, wherein the signal booster is a cellular signal booster.

3. The controllable antenna having the signal booster of claim 1, wherein:
the signal path is an uplink signal path that includes an uplink tap circuit, the uplink signal path coupled between the first port and the second port and configured to pass a wireless uplink signal in a wireless communication network; or
the signal path is a downlink signal path that includes a downlink tap circuit, wherein the downlink signal path is coupled between the second port and the first port and configured to pass a wireless downlink signal in a wireless communication network.

4. The controllable antenna having the signal booster of claim 1, wherein the controllable antenna is configured to be mechanically rotated to direct the beam pattern.

5. The controllable antenna having the signal booster of claim 1, further comprising a rotation unit configured to rotate an antenna according to the control signal.

6. The controllable antenna having the signal booster of claim 1, wherein the controllable antenna is configured to be electrically scanned or electrically steered to direct the beam pattern using one or more antennas.

7. The controllable antenna having the signal booster of claim 1, wherein the controllable antenna is configured to beam steer a signal in the selected direction.

8. The controllable antenna having the signal booster of claim 1, further comprising a plurality of controllable antennas coupled to the first port or the second port.

9. The controllable antenna having the signal booster of claim 8, further comprising selecting one or more of the plurality of antennas to scan for a selected signal or transmit a selected signal in the selected direction.

10. The controllable antenna having the signal booster of claim 8, wherein each of the plurality of controllable antennas are directed independently of other antennas by the control unit to enable each of the plurality of antennas to be directed in a selected direction.

11. The controllable antenna having the signal booster of claim 8, wherein two or more of the plurality of controllable antennas are directed to separate base stations to enable handover of a wireless device in a cellular system from a first base station to a second base station to occur via the separately directed antennas.

12. The controllable antenna having the signal booster of claim 1, wherein the control unit is configured to output the control signal to direct the controllable antenna away from a maximum signal power of the signal to attenuate a received power level of the signal to a selected threshold.

13. A controllable cellular antenna system comprising:
a first directional antenna configured to be directed in a first direction;
a second directional antenna configured to be directed in a second direction, different from the first direction; and
a control unit configured to send a first control signal to direct the first directional antenna and a second control signal to direct the second directional antenna.

14. The controllable cellular antenna system of claim 13, further comprising a rotation unit to rotate the first and second directional antennas based on the first control signal and the second control signal, respectively.

15. The controllable cellular antenna system of claim 13, wherein the control unit is configured to provide the first control signal to electronically beam steer a first plurality of antennas to transmit to or receive from a first base station in the first direction and the second control signal to electronically beam steer a second plurality of antennas to transmit to or receive from a second base station in the second direction.

16. The controllable cellular antenna system of claim 13, wherein the control unit is configured to select one or more of a first plurality of antennas to transmit to or receive from a first base station in the first direction and the control unit is configured to select one or more of a second plurality of antennas to transmit to or receive from a second base station in the second direction.

17. The controllable cellular antenna system of claim 13, wherein the control unit is located at one of a signal booster in communication with the controllable cellular antenna system, a wireless device in communication with the controllable cellular antenna system, and a housing external from the signal booster.

18. A signal booster for a controllable antenna system, comprising:
a signal booster comprising:
a signal path for a signal;
a radio frequency detector unit configured to measure a power level of the signal; and
a control unit configured to receive the power measurement and output a control signal to direct one or more directional antennas in a selected direction.

19. The signal booster for the controllable antenna system of claim 18, further comprising a power level presentation device configured to display the measured power level of the signal to enable the one or more directional antennas to be manually directed based on the displayed power level.

20. The signal booster for the controllable antenna system of claim 18, wherein the radio frequency detector unit is configured to measure a received signal strength indication (RSSI) of the signal.

21. The signal booster for the controllable antenna system of claim 18, wherein the control unit is further configured to output the control signal based on a predetermined geographic location of a base station, relative to a location of the one or more directional antennas to enable the one or more directional antennas to be directed towards the predetermined geographic location.

22. The signal booster for the controllable antenna system of claim 18, wherein the location of the one or more directional antennas is determined using one or more of a known address of a location of the one or more directional antennas, a global positioning system receiver, or one or more inertial sensors.

23. The signal booster for the controllable antenna system of claim 18, wherein the control unit is configured to:
receive a power measurement for a plurality of signals over a selected scan radius;
identify an angle of the one or more directional antennas for each of the received power measurements;
select a signal of the plurality of signals based on the received power measurements and the angle at which each power measurement is received; and
output a control signal to enable the one or more directional antennas to be directed toward the angle of the selected signal.
